(19) United States
(12) Patent Application Publication
(10) Pub. No.: US 2014/0372117 A1
(43) Pub. Date: Dec. 18, 2014

(54) TRANSCRIPTION SUPPORT DEVICE, METHOD, AND COMPUTER PROGRAM PRODUCT

(71) Applicant: Kabushiki Kaisha Toshiba, Tokyo (JP)

(72) Inventors: Kouta NAKATA, Tokyo (JP); Taira ASHIKAWA, Kawasaki-shi (JP); Tomoo IKEDA, Tokyo (JP); Kouji UENO, Kawasaki-shi (JP)

(73) Assignee: Kabushiki Kaisha Toshiba, Tokyo (JP)

(21) Appl. No.: 14/197,694

(22) Filed: Mar. 5, 2014

(30) Foreign Application Priority Data
Jun. 12, 2013 (JP) 2013-124196

(51) Int. Cl. G10L 15/26; G10L 13/08

(52) U.S. Cl. CPC G10L 15/26; G10L 13/08
USPC 704/235

(57) ABSTRACT

According to an embodiment, a transcription support device includes a first voice acquisition unit, a second voice acquisition unit, a recognizer, a text acquisition unit, an information acquisition unit, a determination unit, and a controller. The first voice acquisition unit acquires a first voice to be transcribed. The second voice acquisition unit acquires a second voice uttered by a user. The recognizer recognizes the second voice to generate a first text. The text acquisition unit acquires a second text obtained by correcting the first text by the user. The information acquisition unit acquires reproduction information representing a reproduction section of the first voice. The determination unit determines a reproduction speed of the first voice on the basis of the first voice, the second voice, the second text, and the reproduction information. The controller reproduces the first voice at the determined reproduction speed.

### CROSS-REFERENCE TO RELATED APPLICATIONS

This application is based upon and claims the benefit of priority from Japanese Patent Application No. 2013-124196, filed on Jun. 12, 2013; the entire contents of which are incorporated herein by reference.

### FIELD

Embodiments described herein relate generally to a transcription support device, a transcription support method and a computer program product.

### BACKGROUND

In transcription work, one transcribes the contents of voices into sentences (into text) while listening to recorded voice data, for example. A technique for reducing a burden of the transcription work has been known that recognizes the voice re-uttering the same content as that of the voice to be transcribed after having listened thereto.

The technique in the related, however, does not support the transcription work in accordance with a level of proficiency of work performed by a user. Therefore, a support service employing the technique in the related art is not convenient for a user.

### BRIEF DESCRIPTION OF THE DRAWINGS

FIG. 1 is a diagram illustrating a configuration example of a transcription support system according to an embodiment;

FIG. 2 is a diagram illustrating a use example of a transcription support service according to the embodiment;

FIG. 3 is a diagram illustrating an example of an operation screen of the transcription support service according to the embodiment;

FIG. 4 is a diagram illustrating an example of a functional configuration of the transcription support system according to the embodiment;

FIG. 5 is a flowchart illustrating an example of a process performed in estimating a user speech rate according to the embodiment;

FIG. 6 is a diagram illustrating an example of conversion into a phoneme sequence according to the embodiment;

FIG. 7 is a diagram illustrating an utterance section of a user voice according to the embodiment;

FIG. 8 is a flowchart illustrating an example of a process performed in estimating an original speech rate according to the embodiment;

FIG. 9 is a diagram illustrating an utterance section of an original voice according to the embodiment;

FIG. 10 is a flowchart illustrating an example of a process performed in calculating the adjustment amount for a reproduction speed in a continuous mode according to the embodiment;

FIG. 11 is a flowchart illustrating an example of a process performed in calculating the adjustment amount for the reproduction speed in an intermittent mode according to the embodiment; and

FIG. 12 is a diagram illustrating a configuration example of a transcription support device according to the embodiment.

### DETAILED DESCRIPTION

According to an embodiment, a transcription support device includes a first voice acquisition unit, a second voice acquisition unit, a recognizer, a text acquisition unit, an information acquisition unit, a determination unit, and a controller. The first voice acquisition unit is configured to acquire a first voice to be transcribed. The second voice acquisition unit is configured to acquire a second voice uttered by a user. The recognizer is configured to recognize the second voice to generate a first text. The text acquisition unit is configured to acquire a second text obtained by correcting the first text by the user. The information acquisition unit is configured to acquire reproduction information representing a reproduction section of the first voice. The determination unit is configured to determine a reproduction speed of the first voice on the basis of the first voice, the second voice, the second text, and the reproduction information. The controller is configured to reproduce the first voice at the determined reproduction speed.

Various embodiments will now be described in detail with reference to the attached drawings.

Overview

A function of a transcription support device (hereinafter referred to as a “transcription support function”) according to the present embodiment will be described. The transcription support device according to the present embodiment reproduces or stops voice to be transcribed (hereinafter referred to as an “original voice”) upon receiving an operation instruction from a user. The transcription support device at this time acquires reproduction information in which a reproduction start time and a reproduction stop time of the original voice are recorded. The transcription support device according to the present embodiment recognizes voice (hereinafter referred to as a “user voice”) of a user who repeats a sentence having the same content as that of the original voice after listening to the original voice, to thereby acquire a recognized character string (a first text) as an outcome of voice recognition. The transcription support device according to the present embodiment then displays the recognized character string on a screen, accepts editing input from the user, and acquires text being edited (a second text). The transcription support device according to the present embodiment determines a reproduction speed of the original voice by determining a level of proficiency of work performed by the user on the basis of voice data of the original voice, voice data of the user voice, the text being edited, and the reproduction information on the original voice. The transcription support device according to the present embodiment thereafter reproduces the original voice at the determined reproduction speed. As a result, the transcription support device according to the present embodiment can improve the convenience for the user.

The configuration and the operation of the transcription support function according to the present embodiment will now be described.

System Configuration

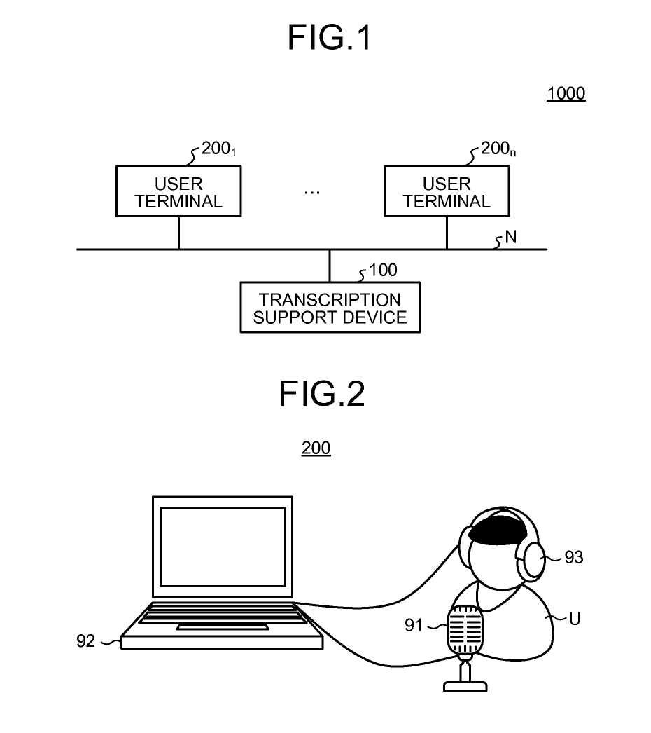

FIG. 1 is a diagram illustrating a configuration example of a transcription support system 1000 according to the present embodiment. As illustrated in FIG. 1, the transcription support system 1000 according to the present embodiment includes a transcription support device 100 as well as one or a plurality of user terminals 200₁ to 200ₙ (hereinafter generically referred to as a “user terminal 200”). All the devices 100 and 200 are connected to one another through a data transmission line N in the transcription support system 1000.

The transcription support device 100 according to the present embodiment includes an arithmetic unit, has a server function, and is thus equivalent to a server device or the like. The user terminal 200 according to the present embodiment includes an arithmetic unit, has a client function, and is thus equivalent to a client device such as a PC (Personal Computer). Note that the user terminal 200 also includes an information terminal such as a tablet. The data transmission line N according to the present embodiment is equivalent to various network channels such as a LAN (Local Area Network), Intranet, Ethernet (registered trademark), or the Internet. Note that the network channel may be wired or wireless.

The transcription support system 1000 according to the present embodiment is assumed to be used in the following situation. FIG. 2 is a diagram illustrating a use example of a transcription support service according to the present embodiment. As illustrated in FIG. 2, for example, a user U first puts a headphone (hereinafter referred to as a “speaker”) 93 connected to the user terminal 200 to his/her ear and listens to the original voice being reproduced. Having listened to the original voice for a fixed period of time, the user U stops reproducing the original voice and utters the content he/she has caught from the original voice toward a microphone 91 connected to the user terminal 200. As a result, the user terminal 200 transmits the user voice input through the microphone 91 to the transcription support device 100. In response, the transcription support device 100 recognizes the user voice received and transmits to the user terminal 200 the recognized character string acquired as an outcome of voice recognition. The outcome of voice recognition of the user voice is then displayed in text on the screen of the user terminal 200. Subsequently, the user U checks whether or not the content of the text being displayed is identical to the content of the original voice he/she has uttered again and, when there is a portion that has been mistakenly recognized, corrects the portion and edits the outcome of voice recognition by inputting correction from a keyboard 92 included in the user terminal 200.

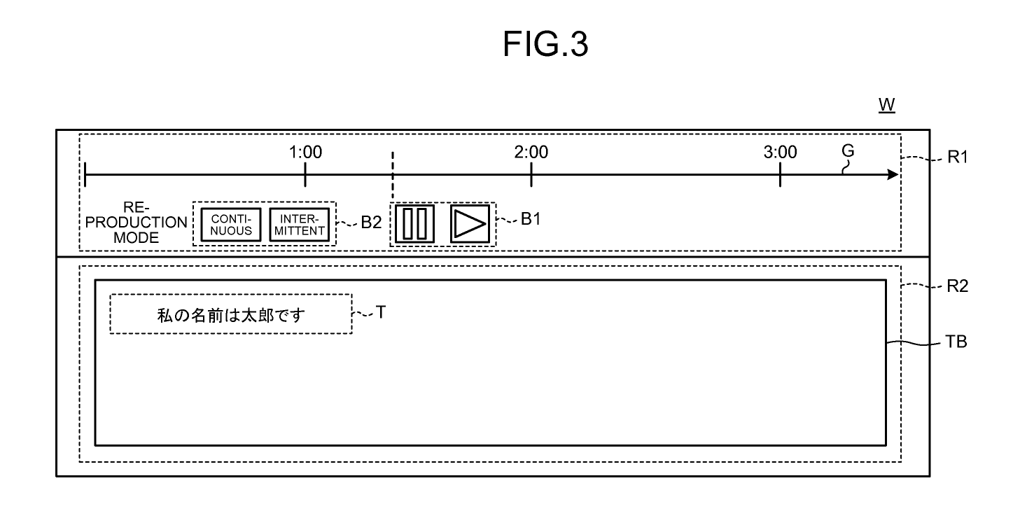

FIG. 3 is a diagram illustrating an example of an operation screen of the transcription support service according to the present embodiment. Displayed in the user terminal 200 is an operation screen W serving as a UI (User Interface) that supports the text transcription work by re-utterance as illustrated in FIG. 3, for example. The operation screen W according to the present embodiment includes an operation region R1 which accepts a reproduction operation of voice and an operation region R2 which accepts an editing operation of the outcome of voice recognition, for example.

The operation region R1 according to the present embodiment includes a UI component (a software component) such as a time gauge G indicating the reproduction time of the voice and a control button B1 by which the reproduction operation of the voice is controlled. Accordingly, the user U can reproduce or stop the voice while checking the reproduction time of the original voice and utter the content caught from the original voice.

The operation region R1 according to the present embodiment further includes a selection button B2 by which a method of reproducing the voice (hereinafter referred to as a “reproduction mode”) is selected. Two reproduction modes including “continuous” and “intermittent” (hereinafter referred to as a “continuous mode” and an “intermittent mode”) can be selected in the present embodiment. The continuous mode corresponds to the reproduction mode used when, while listening to the original voice, the user U performs the re-utterance somewhat late. The voice can be transcribed into text at the same speed the original voice is reproduced when the outcome of voice recognition of the user voice is accurate, because the original voice is not stopped when the user re-utters in the continuous mode. On the other hand, the intermittent mode corresponds to the reproduction mode used when the user U listens to the original voice, pauses the original voice, re-utters, and then resumes the reproduction of the voice (the reproduction mode in which reproduction and stop are repeated). The user U with a low level of proficiency of work sometimes finds it difficult to utter while listening to the original voice when re-uttering. Therefore, the voice can be transcribed into the text in the intermittent mode while pausing the original voice being reproduced and prompting the user U to utter smoothly by giving him/her a timing to re-utter.

Accordingly, the user U can perform the text transcription work by re-utterance while using the reproduction mode in accordance with the level of proficiency of work.

The operation region R2 according to the present embodiment includes a UI component such as a text box TB in which text is edited. FIG. 3 illustrates an example where text T “ [symbol] ” (in English, “My name is Taro”) is displayed as the outcome of voice recognition in the text box TB. The user U can thus edit the outcome of voice recognition by checking whether or not the content of the text T being displayed is identical to the content of the original voice re-uttered and correcting the portion that has been mistakenly recognized.

Accordingly, the transcription support system 1000 according to the present embodiment provides the transcription support function of supporting the text transcription work by re-utterance by employing the aforementioned configuration and UI.

Functional Configuration

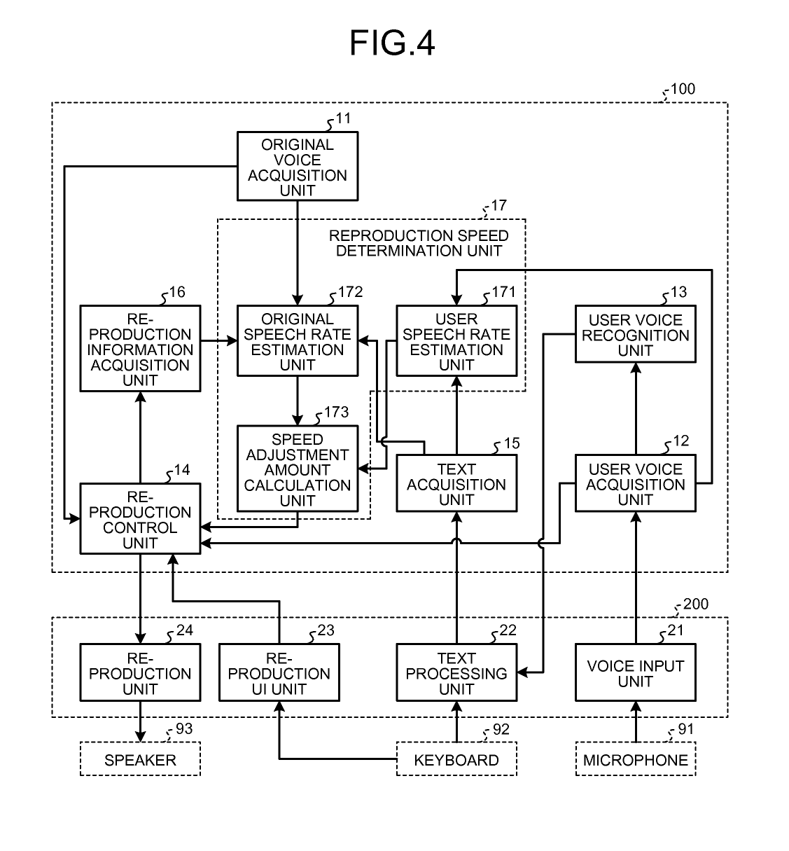

FIG. 4 is a diagram illustrating an example of a functional configuration of the transcription support system 1000 according to the present embodiment. As illustrated in FIG. 4, the transcription support system 1000 according to the present embodiment includes an original voice acquisition unit 11, a user voice acquisition unit 12, a user voice recognition unit 13, a reproduction control unit 14, a text acquisition unit 15, a reproduction information acquisition unit 16, and a reproduction speed determination unit 17. The transcription support system 1000 according to the present embodiment further includes a voice input unit 21, a text processing unit 22, a reproduction UI unit 23, and a reproduction unit 24.

Each of the original voice acquisition unit 11, the user voice acquisition unit 12, the user voice recognition unit 13, the reproduction control unit 14, the text acquisition unit 15, the reproduction information acquisition unit 16, and the reproduction speed determination unit 17 is a functional unit included in the transcription support device 100 according to the present embodiment. Each of the voice input unit 21, the text processing unit 22, the reproduction UI unit 23, and the reproduction unit 24 is a functional unit included in the user terminal 200 according to the present embodiment.

Function of User Terminal 200

The voice input unit 21 according to the present embodiment accepts voice input from the outside through an external device such as the microphone 91 illustrated in FIG. 2. In the transcription support system 1000 according to the present embodiment, the voice input unit 21 accepts the user voice input by the re-utterance.

The text processing unit 22 according to the present embodiment processes text editing. The text processing unit 22 displays the text T of the outcome of voice recognition in the operation region R2 illustrated in FIG. 3, for example. The text processing unit 22 then accepts an editing operation such as character input/deletion performed on the text T being displayed through an external device such as the keyboard 92 illustrated in FIG. 2. In the transcription support system 1000 according to the present embodiment, the text processing unit 22 edits the outcome of voice recognition of the user voice to have the correct content by accepting editing input such as correction of the portion that has been mistakenly recognized.

The reproduction UI unit 23 according to the present embodiment accepts a voice reproduction operation. The reproduction UI unit 23 displays the control button B1 and the selection button B2 (hereinafter generically referred to as a “button B”) in the operation region R1 illustrated in FIG. 3, for example. The reproduction UI unit 23 then accepts an instruction to control reproduction of voice when the button B being displayed is depressed through the external device such as the keyboard 92 (or a pointing device such as a mouse) illustrated in FIG. 2. In the transcription support system 1000 according to the present embodiment, the reproduction UI unit 23 accepts the control instruction to reproduce/stop the original voice in performing the re-utterance as well as an instruction to select the reproduction mode.

The reproduction unit 24 according to the present embodiment reproduces the voice. The reproduction unit 24 outputs the reproduced voice through an external device such as the speaker 93 illustrated in FIG. 2. In the transcription support system 1000 according to the present embodiment, the reproduction unit 24 outputs the original voice being reproduced at the time of the re-utterance.

Function of Transcription Support Device 100

The original voice acquisition unit (a first voice acquisition unit) 11 according to the present embodiment acquires the original voice (a first voice) to be transcribed. For example, the original voice acquisition unit 11 acquires the original voice held in a predetermined storage region of a storage device (or an external storage device) included in or connected to the transcription support device 100. The original voice acquired at this time corresponds to the voice recorded at a meeting or a lecture, for example, and is a piece of voice data that is recorded continuously for a few minutes to a few hours. Note that the original voice acquisition unit 11 may provide a UI function by which the user U can select the original voice, as with the operation screen W illustrated in FIG. 3, for example. In this case, the original voice acquisition unit 11 displays a piece or a plurality of pieces of the voice data as a candidate for the original voice and accepts the result of selection made by the user U. The original voice acquisition unit 11 acquires, as the original voice, the voice data specified from the accepted selection result.

The user voice acquisition unit (a second voice acquisition unit) 12 according to the present embodiment acquires the user voice (a second voice) that is the voice of the user re-uttering the sentence with the same content as that of the original voice after having listened to the original voice. The user voice acquisition unit 12 acquires the user voice input by the voice input unit 21 from the voice input unit 21 included in the user terminal 200. Note that the user voice may be acquired by a passive or active method. The passive acquisition here refers to a method in which the voice data of the user voice transmitted from the user terminal 200 is received by the transcription support device 100. On the other hand, the active acquisition refers to a method in which the transcription support device 100 requests the user terminal 200 to acquire the voice data and acquires the voice data of the user voice that is temporarily held in the user terminal 200.

The user voice recognition unit 13 according to the present embodiment performs a voice recognition process on the user voice. That is, the user voice recognition unit 13 performs the voice recognition process on the voice data acquired by the user voice acquisition unit 12, converts the user voice into the text T (the first text), and acquires the outcome of voice recognition. The user voice recognition unit 13 then transmits the text T acquired as the outcome of voice recognition to the text processing unit 22 included in the user terminal 200. Note that the aforementioned voice recognition process is implemented by employing a known art in the present embodiment. Thus, the description of the voice recognition process according to the present embodiment will be omitted.

The reproduction control unit 14 according to the present embodiment controls the reproduction speed of the original voice. That is, the reproduction control unit 14 controls the reproduction speed of the voice data acquired by the original voice acquisition unit 11. The reproduction control unit 14 at this time reproduces the voice data of the original voice by controlling the reproduction unit 24 included in the user terminal 200 in accordance with the reproduction speed determined by the reproduction speed determination unit 17. The reproduction control unit 14 further controls the original voice to be reproduced/stopped according to the operation instruction accepted from the user terminal 200 (the reproduction UI unit 23) or the user voice acquisition unit 12, the operation instruction corresponding to the control instruction to reproduce or stop the original voice (a control signal to reproduce or stop).

The text acquisition unit 15 according to the present embodiment acquires text T2 (the second text) which is the text T presented to the user and corrected by the user. The text acquisition unit 15 acquires the text T2 being edited by the text processing unit 22 from the text processing unit 22 included in the user terminal 200. The text T2 acquired at this time corresponds to the outcome of voice recognition of the user voice performed by the user voice recognition unit 13 and represents a character string identical to the content of the original voice re-uttered or a character string with the content in which the portion mistakenly recognized has been corrected. Note that the text T2 may be acquired by a passive or active method. The passive acquisition here refers to a method in which the text T2 being edited and transmitted from the user terminal 200 is received by the transcription support device 100. On the other hand, the active acquisition refers to a method in which the transcription support device 100 requests the user terminal 200 to acquire the text T2 and acquires the text T2 being edited and temporarily held in the user terminal 200.

The reproduction information acquisition unit 16 according to the present embodiment acquires the reproduction information representing a reproduction section of the original voice. That is, the reproduction information acquisition unit 16 acquires, as the reproduction information, time information indicating the reproduction section of the original voice the user U has listened to, when the reproduction control unit 14 has stopped the original voice being reproduced at the time of the re-utterance. The reproduction information acquired at this time corresponds to the time information (time stamp information) represented by Expression (1), for example.

(t_{—}os,t_{—}oe)=(0:21.1,0:39.4) (1)

A part “t_os” in the expression represents a reproduction start time of the original voice, while a part “t_oe” in the expression represents a reproduction stop time of the original voice. Indicated by Expression (1) is the reproduction information acquired when the reproduction of the original voice is started at 0 minute and 21.1 seconds and stopped at 0 minute and 39.4 seconds. Accordingly, on the basis of the result of the reproduction control performed by the reproduction control unit 14, the reproduction information acquisition unit 16 acquires, as the reproduction information of the original voice, the time information in which the reproduction start time “t_os” and the reproduction stop time “t_oe” of the original voice are combined, the original voice being reproduced at the time of the re-utterance.

The reproduction speed determination unit 17 according to the present embodiment determines the reproduction speed of the original voice at the time of the re-utterance. The reproduction speed determination unit 17 receives the voice data of the original voice from the original voice acquisition unit 11 and the voice data of the user voice from the user voice acquisition unit 12. The reproduction speed determination unit 17 further receives the text (the second text) being edited from the text acquisition unit 15 and the reproduction information of the original voice from the reproduction information acquisition unit 16. On the basis of the data received from these functional units, the reproduction speed determination unit 17 determines an appropriate reproduction speed of the original voice at the time of the re-utterance according to the level of proficiency of work performed by the user U. Specifically, the reproduction speed determination unit 17 determines the level of proficiency of work performed by the user U on the basis of the voice data of the original voice, the voice data of the user voice, the text being edited, and the reproduction information of the original voice. From the determination result, the reproduction speed determination unit 17 determines the reproduction speed of the original voice at the time of the re-utterance for each user U. Now, the reproduction speed determination unit 17 according to the present embodiment includes a user speech rate estimation unit 171, an original speech rate estimation unit 172, and a speed adjustment amount calculation unit 173.

Details

The operation of the reproduction speed determination unit 17 according to the present embodiment will now be described in detail for each of the aforementioned functional units.

Details of Reproduction Speed Determination Unit 17

User Speech Rate Estimation Unit 171

The user speech rate estimation unit (a second speech rate estimation unit) 171 according to the present embodiment estimates the speech rate of the user U (hereinafter referred to as a “user speech rate”) at the time of the re-utterance. The user speech rate estimation unit 171 converts the text T acquired as the outcome of voice recognition into a phoneme sequence equivalent to a pronunciation unit and performs forced alignment between the phoneme sequence and the user voice. Here, the user speech rate estimation unit 171 specifies the position of the phoneme sequence in the user voice from the number of occurrences of a linguistic element, such as a phoneme, per unit time. The user speech rate estimation unit 171 thereby specifies an utterance section of the user U (hereinafter referred to as a “user utterance section”) in the user voice. The user speech rate estimation unit 171 then estimates the user speech rate (a second speech rate) from the length of the phoneme sequence (the number of phonemes in the text T) and the length (the period of utterance) of the user utterance section (a second utterance section). Specifically, the user speech rate estimation unit 171 estimates the user speech rate of the user voice by a process as follows.

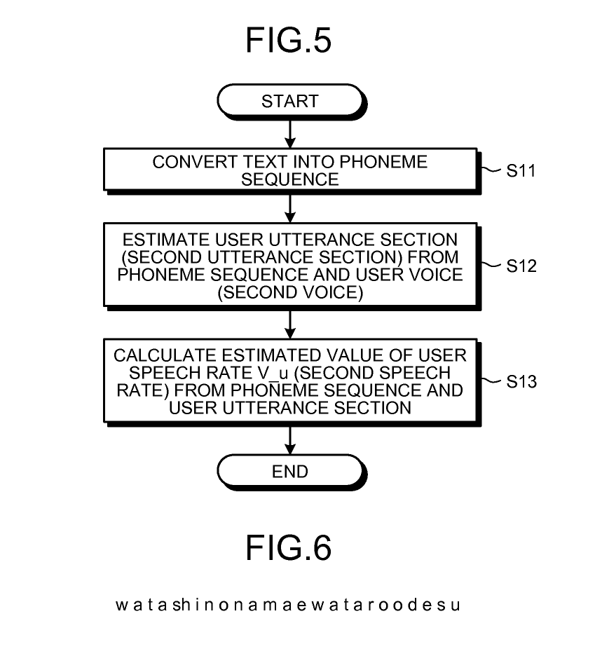

FIG. 5 is a flowchart illustrating an example of the process performed in estimating the user speech rate according to the present embodiment. As illustrated in FIG. 5, the user speech rate estimation unit 171 according to the present embodiment first converts the text T into the phoneme sequence (step S11). This conversion into the phoneme sequence is performed by employing a known art such as conversion into kana representing the reading of the text based on a dictionary or a context, for example.

FIG. 6 is a diagram illustrating an example of conversion into the phoneme sequence according to the present embodiment. Having acquired the text T “ [symbol] ” (in English, “My name is Taro”) as the outcome of voice recognition, for example, the user speech rate estimation unit 171 converts “ [symbol] ” into kana representing the reading of the text and thereafter converts it into the phoneme sequence. As a result, the user speech rate estimation unit 171 acquires the phoneme sequence “w at a sh i n o n a m a e w a t a r o o d e s u” including twenty-four phonemes (number of phonemes) as illustrated in FIG. 6.

Referring back to the description in FIG. 5, the user speech rate estimation unit 171 estimates the user utterance section in the user voice from the phoneme sequence and the user voice (step S12). Here, the user speech rate estimation unit 171 estimates the user utterance section by associating the phoneme sequence with the user voice by the forced alignment.

In performing the re-utterance, the user U does not necessarily start uttering at the same time the recording is started and end uttering at the same time the recording is ended, for example. Therefore, there is a possibility that a filler word which is in front and behind the portion to be transcribed in the original voice and has not been transcribed or surrounding noise caught in the recording environment are recorded. This means that the recording time of the user voice includes the user utterance section as well as a user non-utterance section. The user speech rate estimation unit 171 thus estimates the user utterance section required to estimate the accurate user speech rate.

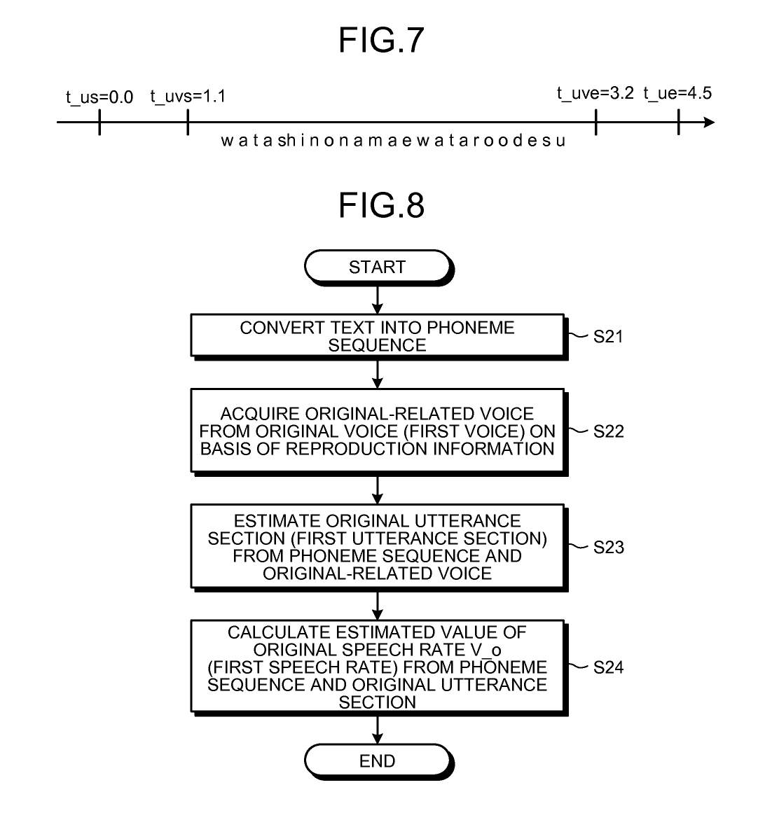

FIG. 7 is a diagram illustrating the utterance section of the user voice (the user utterance section) according to the present embodiment. FIG. 7 illustrates the user voice with the recording time of 4.5 seconds (t_us=0.0 second to t_ue=4.5 seconds). Within that time, the user utterance section corresponding to the phoneme sequence of the text “ [symbol] ” falls within 2.1 seconds from t_uvs=1.1 seconds to t_uve=3.2 seconds. The user speech rate estimation unit 171 makes the correspondence relation between the phoneme sequence of the text “ [symbol] ” and the user voice by the forced alignment, thereby estimating an utterance start time t_uvs and an utterance stop time t_uve of the user U in the user voice. Accordingly, the user speech rate estimation unit 171 can accurately estimate the user utterance section in the user voice to last for 2.1 seconds, not for 4.5 seconds that is the recording time including the user non-utterance section.

Referring back to the description in FIG. 5, the user speech rate estimation unit 171 estimates a user speech rate V_u in the user voice from the length of the phoneme sequence and the length of the user utterance section (step S13). Here, the user speech rate estimation unit 171 uses Expression (2) to calculate an estimated value of the user speech rate V_u in the user voice.

V_{—}u=l_{—}ph/dt_{—}u (2)

A part “l_ph” in the expression represents the length of the phoneme sequence of the text T, while a part “dt_u” in the expression represents the length of the user utterance section. Therefore, the estimated value of the user speech rate V_u calculated by Expression (2) is equal to an average value of the number of phonemes uttered per second in the user utterance section. In the present embodiment, for example, the estimated value of the user speech rate V_u is calculated to be 11.5 with the length dt_u of the user utterance section equal to 2.1 seconds and the length l_ph of the phoneme sequence of the text T equal to 24 phonemes. Accordingly, the user speech rate estimation unit 171 calculates the average value of the number of phonemes per unit time in the user utterance section and lets the calculated value be the estimated value of the user speech rate V_u.

Original Speech Rate Estimation Unit 172

The original speech rate estimation unit (a first speech rate estimation unit) 172 according to the present embodiment estimates the speech rate of the original voice (hereinafter referred to as an “original speech rate”) reproduced at the time of the re-utterance. The original speech rate estimation unit 172 converts the text T acquired as the outcome of voice recognition into the phoneme sequence equivalent to the pronunciation unit. On the basis of the reproduction information of the original voice at the time of the re-utterance, the original speech rate estimation unit 172 acquires what is supposed to be the voice data of the voice corresponding to the content of the text T (hereinafter referred to as an “original-related voice”) from the original voice. Note that the content of the text T corresponds to the content of what is re-uttered by the user U among the original voice. The original speech rate estimation unit 172 performs the forced alignment between the phoneme sequence and the original-related voice. Here, the original speech rate estimation unit 172 specifies the position of the phoneme sequence in the original-related voice. The original speech rate estimation unit 172 thereby specifies a section of the original-related voice re-uttered by the user U (hereinafter referred to as an “original utterance section”). The original speech rate estimation unit 172 then estimates the original speech rate (a first speech rate) from the length of the phoneme sequence and the length of the original utterance section (a first utterance section). Specifically, the original speech rate estimation unit 172 estimates the original speech rate of the original voice by a process as follows.

FIG. 8 is a flowchart illustrating an example of a process performed in estimating the original speech rate according to the present embodiment. As illustrated in FIG. 8, the original speech rate estimation unit 172 according to the present embodiment first converts the text T into the phoneme sequence (step S21). This conversion into the phoneme sequence is performed by employing a known art as is the case with the user speech rate estimation unit 171. Having acquired the text T “ [symbol] ” as the outcome of voice recognition, for example, the original speech rate estimation unit 172 converts “ [symbol] ” into kana representing the reading of the text and thereafter converts it into the phoneme sequence. As a result, the original speech rate estimation unit 172 acquires the phoneme sequence including the twenty-four phonemes (number of phonemes) as illustrated in FIG. 6.

The original speech rate estimation unit 172 thereafter acquires the original-related voice from the original voice on the basis of the reproduction information (step S22).

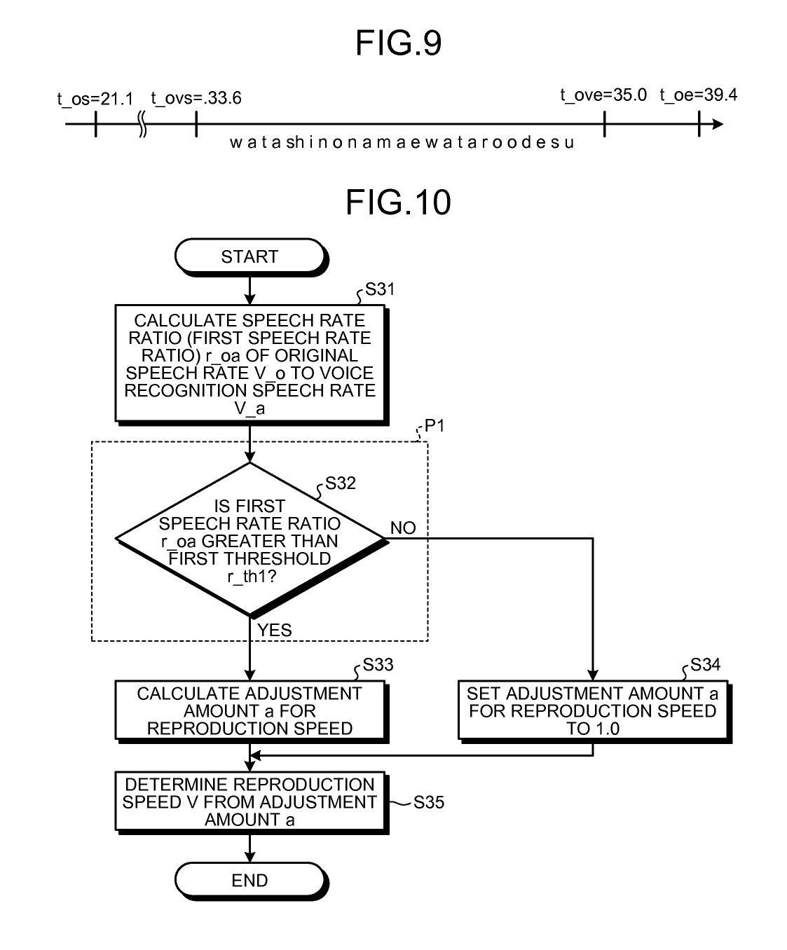

FIG. 9 is a diagram illustrating the utterance section of the original voice (the original utterance section) according to the present embodiment. FIG. 9 illustrates the original voice with the reproduction time of 18.3 seconds (t_os=21.1 seconds to t_oe=39.4 seconds). This reproduction time indicates the time during which the user U has reproduced/stopped the original voice, re-uttered the content “ [symbol] ” he/she has caught from the original voice, and the voice recognition of the re-uttered voice has been completed. Accordingly, the original speech rate estimation unit 172 acquires, as the original-related voice, the voice data from the reproduction start time t_os=21.1 seconds to the reproduction stop time t_oe=39.4 seconds.

Next, the original speech rate estimation unit 172 estimates the original utterance section in the original-related voice from the phoneme sequence and the original-related voice (step S23). The original speech rate estimation unit 172 here estimates the original utterance section by associating the phoneme sequence with the original-related voice by the forced alignment.

The user U does not necessarily re-utter all the content of the original voice being reproduced at the time of the re-utterance, for example. This is because the original voice possibly includes a section which need not be transcribed such as the noise of looking for material during a meeting or chat during a break. The recording time of the original voice thus includes the original utterance section re-uttered by the user U to be transcribed as well as an original non-utterance section not re-uttered by the user U since the section need not be transcribed. Therefore, the original speech rate estimation unit 172 estimates the original utterance section in order to estimate the accurate original speech rate.

FIG. 9 illustrates the example where the voice data from the reproduction start time t_os=21.1 seconds to the reproduction stop time t_oe=39.4 seconds has been acquired as the original-related voice among the original voice. Within that time, the original utterance section supposedly including the voice corresponding to the phoneme sequence of the text “ [symbol] ” falls within 1.4 seconds from t_ovs=33.6 seconds to t_ove=35.0 seconds. The original speech rate estimation unit 172 makes the correspondence relation between the phoneme sequence of the text “ [symbol] ” and the original-related voice by the forced alignment, thereby estimating a re-utterance start time t_ovs and a re-utterance stop time t_ove of the user U in the original-related voice. Accordingly, the original speech rate estimation unit 172 can estimate the original utterance section in the original-related voice to last for 1.4 seconds, not for 18.3 seconds that is the recording time including the original non-utterance section.

Referring back to the description in FIG. 8, the original speech rate estimation unit 172 estimates an original speech rate V_o in the original voice from the length of the phoneme sequence and the length of the original utterance section (step S24). Here, the original speech rate estimation unit 172 uses Expression (3) to calculate an estimated value of the original speech rate V_o in the original-related voice.

V_{—}o=l_{—}ph/dt_{—}o (3)

A part l_ph in the expression represents the length of the phoneme sequence of the text T, while a part dt_o in the expression represents the length of the original utterance section. Therefore, the estimated value V_o of the original speech rate calculated by Expression (3) is equal to an average value of the number of phonemes re-uttered by the user per second in the original utterance section. In the present embodiment, for example, the estimated value V_o of the original speech rate is calculated to be 18.0 with the length dt_o of the original utterance section equal to 1.4 seconds and the length l_ph of the phoneme sequence of the text T equal to 24 phonemes. Accordingly, the original speech rate estimation unit 172 calculates the average value of the number of phonemes per unit time in the original utterance section and lets the calculated value be the estimated value of the original speech rate V_o.

Speed Adjustment Amount Calculation Unit 173

The speed adjustment amount calculation unit 173 according to the present embodiment calculates the adjustment amount used to determine the reproduction speed of the original voice at the time of the re-utterance in accordance with the level of proficiency of work performed by the user U. The adjustment amount calculated by the speed adjustment amount calculation unit 173 is multiplied by the number of data samples per one second of voice, for example, so as to be equal to a coefficient value with which the speed can be adjusted.

The speed adjustment amount calculation unit 173 performs a calculation process that is different for each reproduction mode of the original voice at the time of the re-utterance. Specifically, when the reproduction mode is in the continuous mode (continuous reproduction), the speed adjustment amount calculation unit 173 calculates the adjustment amount while considering the accuracy of voice recognition on the basis of a ratio of the estimated value of the original speech rate V_o received from the original speech rate estimation unit 172 to a set value V_a of a voice recognition speech rate. When the reproduction mode is in the intermittent mode (intermittent reproduction), the speed adjustment amount calculation unit 173 determines the level of proficiency of work performed by the user U on the basis of a ratio of the estimated value of the user speech rate V_u received from the user speech rate estimation unit 171 to the estimated value of the original speech rate V_o received from the original speech rate estimation unit 172, and thereafter calculates the adjustment amount according to the level of proficiency of work. Note that the voice recognition speech rate corresponds to a speech rate suitable for voice recognition and can be preset according to a learning method of voice recognition (recognition performance of the user voice recognition unit 13), for example (can be provided beforehand according to the learning method). The set value of the voice recognition speech rate V_a in the present embodiment is set to 10.0 for the sake of convenience.

(A) Continuous Mode

FIG. 10 is a flowchart illustrating an example of a process performed in calculating the adjustment amount for the reproduction speed in the continuous mode according to the present embodiment. As illustrated in FIG. 10, the speed adjustment amount calculation unit 173 according to the present embodiment first calculates a speech rate ratio (hereinafter referred to as a “first speech rate ratio”) r_oa representing the ratio of the original speech rate V_o to the voice recognition speech rate V_a (step S31). Here, the speed adjustment amount calculation unit 173 calculates the first speech rate ratio r_oa by using Expression (4).

r_{—}oa=V_{—}o/V_{—}a (4)

The speed adjustment amount calculation unit 173 then compares the calculated first speech rate ratio r_oa with a threshold (hereinafter referred to as a “first threshold”) r_th1 and determines whether or not the first speech rate ratio r_oa is greater than the first threshold r_th1 (step S32). The first threshold r_th1 can be preset as a criterion for determining whether the original speech rate V_o is sufficiently greater than the voice recognition speech rate V_a (or can be provided beforehand as a criterion). The first threshold r_th1 in the present embodiment is set to 1.4 for the sake of convenience.

Accordingly, the speed adjustment amount calculation unit 173 calculates an adjustment amount “a” for the reproduction speed of the original voice at the time of the re-utterance (step S33) when the first speech rate ratio r_oa is determined to be greater than the first threshold r_th1 (step S32: Yes). The speed adjustment amount calculation unit 173 at this time uses Expression (5) to calculate the adjustment amount “a” for the reproduction speed.

a=V_{—}a/V_{—}o (5)

On the other hand, the speed adjustment amount calculation unit 173 sets the adjustment amount “a” for the reproduction speed of the original voice at the time of the re-utterance to 1.0 (step S34) when the first speech rate ratio r_oa is smaller than or equal to the first threshold r_th1 (step S32: No).

The reproduction speed determination unit 17 thereby determines the reproduction speed V of the original voice at the time of the re-utterance from the adjustment amount “a” calculated (or set) by the speed adjustment amount calculation unit 173 (step S35). Here, the reproduction speed determination unit 17 determines the reproduction speed V by multiplying the number of data samples per second in the current original voice by the adjustment amount “a” and setting the multiplied value to be the number of data samples after adjustment.

In response, the reproduction control unit 14 reproduces the original voice at the reproduction speed V determined by the reproduction speed determination unit 17. The reproduction speed V of the original voice at the time of the re-utterance in the continuous mode is adjusted as described above in the transcription support device 100 according to the present embodiment.

The aforementioned example of the process will now be described while using a specific value. In the present embodiment, the first speech rate ratio r_oa is calculated to be 1.8 in the calculation process performed in step S31 with the estimated value of the original speech rate V_o equal to 18.0 and the set value of the voice recognition speech rate V_a equal to 10.0. It is therefore determined by the determination process performed in step S32 that the first speech rate ratio r_oa is greater than the first threshold r_th1 (1.8>1.4). As a result, the process proceeds to the calculation process in step S33, where the adjustment amount “a” for the reproduction speed V is calculated to be 0.556 with the estimated value V_o of the original speech rate equal to 18.0 and the set value of the voice recognition speech rate V_a equal to 10.0. Therefore, the original voice is reproduced at a speed 44.4% slower than the current speed at the time of the re-utterance in the present embodiment.

On the other hand, the first speech rate ratio r_oa is calculated to be 1.2 in the calculation process performed in step S31 when the estimated value V_o of the original speech rate is equal to 12.0, for example. It is thus determined by the determination process performed in step S32 that the first speech rate ratio r_oa is smaller than the first threshold r_th1 (1.2<1.4). As a result, the process proceeds to the setting process in step S34 where the adjustment amount “a” for the reproduction speed V is set to 1.0. In this case, the original voice is reproduced at the same speed as the current speed in performing the re-utterance.

Where the voice is reproduced in the continuous mode, while listening to the original voice, the user U performs the re-utterance somewhat late. At that time, the user U re-utters the voice at the same speech rate as the original voice in order to not have a pause in the utterance as much as possible. It is however possible, when the original voice is the voice data obtained by recording ordinary conversation at a meeting or the like, that the speech rate of the original voice is faster than the speech rate suitable for the voice recognition. As a result, there is a possibility that the accuracy of recognizing the user voice decreases when the user U re-utters the voice at the same speech rate as the original voice, the user voice corresponding to the re-utterance being recorded.

The speed adjustment amount calculation unit 173 in the present embodiment thus compares the first speech rate ratio r_oa with the first threshold r_th1 and determines from the comparison result whether or not the original speech rate V_o is suitable for the voice recognition, as illustrated by a process P1 in FIG. 10. As a result, the speed adjustment amount calculation unit 173 determines the reproduction speed V at which the original voice is reproduced at a speech rate close to the voice recognition speech rate V_a when the original speech rate V_o is faster than the voice recognition speech rate V_a and is not suitable for the voice recognition. The transcription support device 100 according to the present embodiment thus provides an environment where the user can perform the transcription work while listening to the original voice with the speech rate adjusted to what is suitable for the voice recognition. Accordingly, in the transcription support device 100 according to the present embodiment, one can accurately recognize the user voice in which the re-utterance is recorded so that the burden of the transcription work on the user U can be reduced (cost of the transcription work can be reduced).

(B) Intermittent Mode

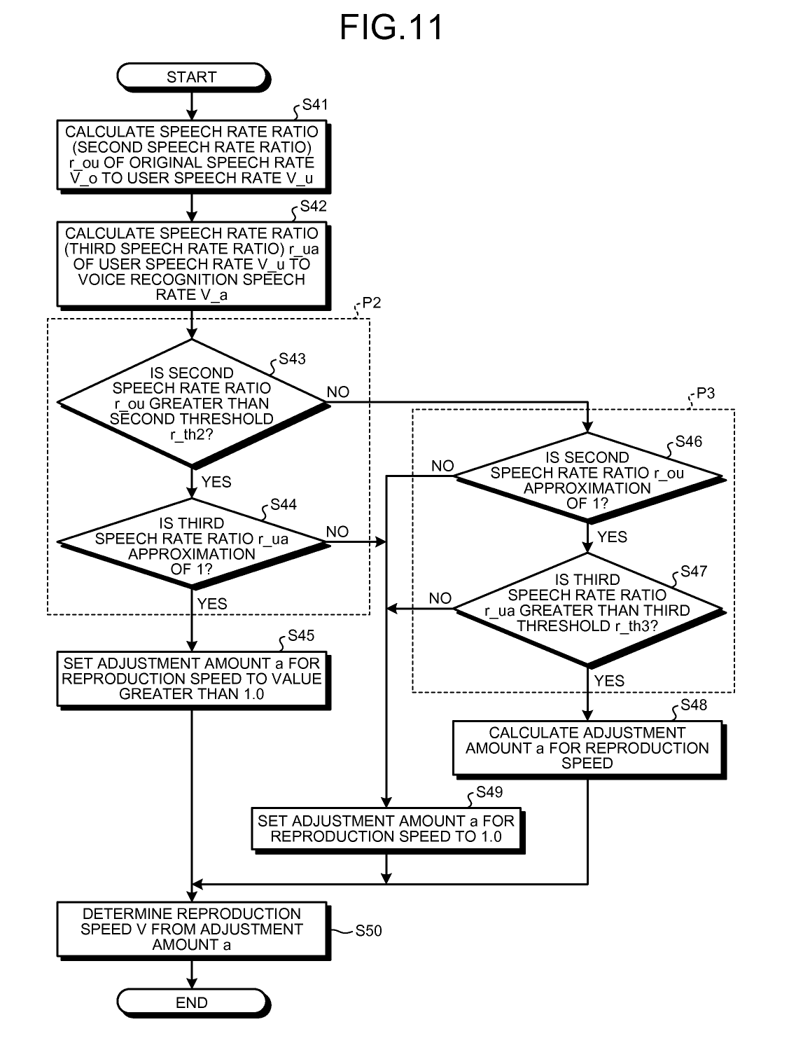

FIG. 11 is a flowchart illustrating an example of a process performed in calculating the adjustment amount for the reproduction speed in the intermittent mode according to the present embodiment. As illustrated in FIG. 11, the speed adjustment amount calculation unit 173 according to the present embodiment first calculates a speech rate ratio (hereinafter referred to as a “second speech rate ratio”) r_ou representing a ratio of the original speech rate V_o to the user speech rate V_u (step S41). The speed adjustment amount calculation unit 173 here uses Expression (6) to calculate the second speech rate ratio r_ou.

r_{—}ou=V_{—}o/V_{—}u (6)

The speed adjustment amount calculation unit 173 then calculates a speech rate ratio (hereinafter referred to as a “third speech rate ratio”) r_ua representing a ratio of the user speech rate V_u to the voice recognition speech rate V_a (step S42). Here, the speed adjustment amount calculation unit 173 uses Expression (7) to calculate the third speech rate ratio r_ua.

r_{—}ua=V_{—}u/V_{—}a (7)

The speed adjustment amount calculation unit 173 thereafter compares the calculated second speech rate ratio r_ou with a threshold (hereinafter referred to as a “second threshold”) r_th2 and determines whether or not the second speech rate ratio r_ou is greater than the second threshold r_th2 (step S43). Note that the second threshold r_th2 can be preset as a criterion for determining whether the original speech rate V_o is sufficiently greater than the user speech rate V_u (can be provided beforehand as a criterion). The second threshold r_th2 in the present embodiment is set to 1.4 for the sake of convenience.

The speed adjustment amount calculation unit 173 determines whether or not the calculated third speech rate ratio r_ua is an approximation of 1 (step S44) when the second speech rate ratio r_ou is greater than the second threshold r_th2 (step S43: Yes). Here, the speed adjustment amount calculation unit 173 uses Conditional Expression (C1) to determine whether or not the third speech rate ratio r_ua is the approximation of 1.

1−e<r_{—}ua<1+e (C1)

A part “e” in the expression can be preset as a number range of a criterion for determining whether the third speech rate ratio r_ua is the approximation of 1 (can be provided beforehand as the number range of the criterion). Therefore, the “e” can be adjusted by setting thereto a value smaller than 1 in Conditional Expression (C1) such that the condition is satisfied when the third speech rate ratio r_ua is the approximation of 1 within the number range of ±e. The “e” in the present embodiment is set to 0.2 for the sake of convenience. In the present embodiment, Conditional Expression (C1) is satisfied when the third speech rate ratio r_ua is greater than 0.8 and smaller than 1.2.

Accordingly, the speed adjustment amount calculation unit 173 sets the adjustment amount “a” for the reproduction speed V of the original voice at the time of the re-utterance to a predetermined value greater than 1 (step S45) when the third speech rate ratio r_ua is the approximation of 1 (step S44: Yes). The predetermined value set as the adjustment amount “a” in the present embodiment is set to 1.5 for the sake of convenience.

The speed adjustment amount calculation unit 173 determines whether or not the second speech rate ratio r_ou is the approximation of 1 (step S46) when the second speech rate ratio r_ou is smaller than or equal to the second threshold r_th2 (step S43: No). Here, the speed adjustment amount calculation unit 173 uses Conditional Expression (C2) to determine whether or not the second speech rate ratio r_ou is the approximation of 1.

1−e<r_{—}ou<1+e (C2)

A part “e” in the expression can be preset as a number range of a criterion for determining whether the second speech rate ratio r_ou is the approximation of 1 (can be provided beforehand as the number range of the criterion). Therefore, the “e” can be adjusted by setting thereto a value smaller than 1 in (Conditional expression 2) such that the condition is satisfied when the second speech rate ratio r_ou is the approximation of 1 within the number range of ±e. The “e” in the present embodiment is set to 0.2 for the sake of convenience. In the present embodiment, Conditional Expression (C2) is satisfied when the second speech rate ratio r_ou is greater than 0.8 and smaller than 1.2.

When the second speech rate ratio r_ou is the approximation of 1 (step S46: Yes), the speed adjustment amount calculation unit 173 compares the third speech rate ratio r_ua with a threshold (hereinafter referred to as a “third threshold”) r_th3 and determines whether or not the third speech rate ratio r_ua is greater than the third threshold r_th3 (step S47). Note that the third threshold r_th3 can be preset as a criterion for determining whether the user speech rate V_u is sufficiently greater than the voice recognition speech rate V_a (can be provided beforehand as a criterion). The third threshold r_th3 in the present embodiment is set to 1.4 for the sake of convenience.

Accordingly, the speed adjustment amount calculation unit 173 calculates the adjustment amount “a” for the reproduction speed V of the original voice at the time of the re-utterance (step S48) when the third speech rate ratio r_ua is greater than the third threshold r_th3 (step S47: Yes). The speed adjustment amount calculation unit 173 here uses Expression (8) to calculate the adjustment amount “a” for the reproduction speed V.

a=V_{—}a/V_{—}u (8)

The speed adjustment amount calculation unit 173 sets the adjustment amount “a” for the reproduction speed V of the original voice at the time of the re-utterance to be 1.0 (step S49) when the third speech rate ratio r_ua is not the approximation of 1 (step S44: No). Likewise, the speed adjustment amount calculation unit 173 sets the adjustment amount “a” to 1.0 when the second speech rate ratio r_ou is not the approximation of 1 (step S46: No) or when the third speech rate ratio r_ua is smaller than or equal to the third threshold r_th3 (step S47: No).

The reproduction speed determination unit 17 thereby determines the reproduction speed of the original voice at the time of the re-utterance from the adjustment amount “a” calculated (or set) by the speed adjustment amount calculation unit 173 (step S50). As is the case with the continuous mode, the reproduction speed determination unit 17 determines the reproduction speed V by multiplying the current number of data samples per one second of the original voice by the adjustment amount “a” and setting the multiplied value to be the number of data samples after adjustment.

In response, the reproduction control unit 14 reproduces the original voice at the reproduction speed V determined by the reproduction speed determination unit 17. The reproduction speed V of the original voice at the time of the re-utterance in the intermittent mode is adjusted as described above in the transcription support device 100 according to the present embodiment.

The aforementioned example of the process will now be described while using a specific value. In the present embodiment, the second speech rate ratio r_ou is calculated to be 1.565 in the calculation process performed in step S41 with the estimated value of the original speech rate V_o equal to 18.0 and the estimated value of the user speech rate V_u e equal to 11.5. Moreover, in the present embodiment, the third speech rate ratio r_ua is calculated to be 1.15 in the calculation process performed in step S42 with the estimated value of the user speech rate V_u equal to 11.5 and the set value of the voice recognition speech rate V_a equal to 10.0. It is therefore determined that the second speech rate ratio r_ou is greater than the second threshold r_th2 (1.565>1.4) by the determination process performed in step S43 and that the third speech rate ratio r_ua is the approximation of 1 (0.8<1.15<1.2) by the determination process performed in step S44. As a result, the process proceeds to the setting process in step S45, where the adjustment amount “a” of the reproduction speed V is set to 1.5. Therefore, the original voice is reproduced at a speed 1.5 times faster than the current speed at the time of the re-utterance in the present embodiment.

When the estimated value of the original speech rate V_o is equal to 15.0, the second speech rate ratio r_ou is calculated to be 1.304 with the estimated value of the user speech rate V_u equal to 11.5 in the calculation process performed in step S41, for example. It is thus determined by the determination process performed in step S43 that the second speech rate ratio r_ou is smaller than the second threshold r_th2 (1.304<1.4). In response, the process proceeds to the determination process in step S46 where it is determined that the second speech rate ratio r_ou is not the approximation of 1 (1.304>1.2), while it is determined that the third speech rate ratio r_ua is greater than the third threshold r_th3 (1.565>1.4) by the determination process performed in step S47. As a result, the process proceeds to the setting process in step S48, where the adjustment amount “a” for the reproduction speed V is calculated to be 0.87 with the estimated value of the user speech rate V_u equal to 11.5 and the set value of the voice recognition speech rate V_a equal to 10.0. The original voice in this case is reproduced at a speed 13% slower than the current speed at the time of the re-utterance.

When the third speech rate ratio r_ua or the second speech rate ratio r_ou is not the approximation of 1, on the other hand, the process proceeds to the setting process in step S49 where the adjustment amount “a” for the reproduction speed V is set to 1.0. This also applies to the case where the third speech rate ratio r_ua is smaller than or equal to the third threshold r_th3. In this case, the original voice is reproduced at the same speed as the current speed at the time of the re-utterance.

Where the voice is reproduced in the intermittent mode, the user U listens to the original voice for a fixed period of time and then re-utters the voice while pausing the reproduction of the original voice. At this time, the user U with a high level of proficiency of work is capable of re-uttering the voice at a speech rate suitable for the voice recognition of the user voice without being influenced by the speech rate of the original voice. It is therefore preferred to increase the reproduction speed V of the original voice in order to efficiently perform the transcription work.

The speed adjustment amount calculation unit 173 in the present embodiment thus compares the second speech rate ratio r_ou with the second threshold r_th2 and determines from the comparison result whether or not the user speech rate V_u is slower than the original speech rate V_o, as illustrated by a process P2 in FIG. 11. The speed adjustment amount calculation unit 173 further determines whether or not the third speech rate r_ua is the approximation of 1. That is, the speed adjustment amount calculation unit 173 checks whether the user speech rate V_u is slower than the original speech rate V_o by comparing the original speech rate V_o with the user speech rate V_u. When the user speech rate V_u is slower than the original speech rate V_o, the speed adjustment amount calculation unit 173 further checks whether the user speech rate V_u and the voice recognition speech rate V_a approximate each other by comparing the user speech rate V_u with the voice recognition speech rate V_a. The speed adjustment amount calculation unit 173 consequently determines that the user U possesses the high level of proficiency of work and is capable of re-uttering the voice in a stable manner at the speech rate suitable for the voice recognition regardless of the speech rate of the original voice, when the user speech rate V_u is slower than the original speech rate V_o and approximates to the voice recognition speech rate V_a. In response, the reproduction speed determination unit 17 determines the reproduction speed V at which the original voice is reproduced, the reproduction speed V being faster than the current reproduction speed.

The transcription support device 100 according to the present embodiment thus provides an environment where the user can perform the transcription work while listening to the original voice, the speech rate of which is adjusted for the transcription work to be performed efficiently. As a result, in the transcription support device 100 according to the present embodiment, the transcription work can be performed efficiently so that the burden of the transcription work on the user U with the high level of proficiency of work can be reduced (the cost of the transcription work can be reduced). The transcription support system 1000 according to the present embodiment can provide a support service intended for an expert.

On the other hand, the user U with a low level of proficiency of work can possibly re-utter the voice at a speech rate influenced by that of the original voice he/she has listened to just before re-uttering. It is therefore possible, when the original speech rate V_o is faster than the voice recognition speech rate V_a, that the user U re-utters the voice at the same speech rate as that of the original voice so that the accuracy of recognizing the user voice is decreased, the user voice corresponding to the re-utterance being recorded.

The speed adjustment amount calculation unit 173 in the present embodiment thus determines whether or not the second speech rate r_ou is the approximation of 1 as illustrated by a process P3 in FIG. 11. The speed adjustment amount calculation unit 173 further compares the third speech rate ratio r_ua with the third threshold r_th3 and determines from the comparison result whether or not the user speech rate V_u is faster than the voice recognition speech rate V_a. That is, the speed adjustment amount calculation unit 173 checks whether the user speech rate V_u and the original speech rate V_o approximate each other by comparing the original speech rate V_o with the user speech rate V_u. When the user speech rate V_u and the original speech rate V_o approximate each other, the speed adjustment amount calculation unit 173 further checks whether the user speech rate V_u is faster than the voice recognition speech rate V_a by comparing the user speech rate V_u with the voice recognition speech rate V_a. The speed adjustment amount calculation unit 173 consequently determines that the user U possesses the low level of proficiency of work and re-utters the voice at the speech rate which can possibly decrease the accuracy of the voice recognition while being influenced by the speech rate of the original voice, when the user speech rate V_u approximates the original speech rate V_o and is faster than the voice recognition speech rate V_a. In response, the reproduction speed determination unit 17 determines the reproduction speed V at which the original voice is reproduced, the reproduction speed V being slower than the current reproduction speed.

The transcription support device 100 according to the present embodiment thus provides an environment where the user U can perform the transcription work while listening to the original voice, the speech rate of which is adjusted to what is suitable for the voice recognition. As a result, in the transcription support device 100 according to the present embodiment, the user voice including the recorded re-utterance can be recognized accurately so that the burden of the transcription work on the user U with the low level of proficiency of work can be reduced (the cost of the transcription work can be reduced). The transcription support system 1000 according to the present embodiment can provide a support service intended for a beginner.

### SUMMARY

As described above, the transcription support device 100 according to the present embodiment reproduces or stops the original voice upon receiving the operation instruction from the user U. The transcription support device 100 at this time acquires the reproduction information in which the reproduction start time and the reproduction stop time of the original voice are recorded. The transcription support device 100 according to the present embodiment acquires the text T (the recognized character string) as the outcome of voice recognition by recognizing the user voice input by the user U who re-utters the same content as that of the original voice after having listened thereto. The transcription support device 100 according to the present embodiment then displays the text T on the screen, accepts the editing input from the user U, and acquires the text T2 being edited. The transcription support device 100 according to the present embodiment determines the reproduction speed V of the original voice at the time of the re-utterance by determining the level of proficiency of work performed by the user U on the basis of the voice data of the original voice, the voice data of the user voice, the text T2 being edited, and the reproduction information on the original voice. The transcription support device 100 according to the present embodiment thereafter reproduces the original voice at the determined reproduction speed V, the original voice being reproduced at the time of the re-utterance.

The transcription support device 100 according to the present embodiment can thus provide the environment where the reproduction speed V of the original voice at the time of the re-utterance can be adjusted to the speed appropriate for each user U. As a result, the transcription support device 100 according to the present embodiment can support the text transcription work by the re-utterance in accordance with the level of proficiency of work performed by the user U. The transcription support device 100 according to the present embodiment also provides the environment where the reproduction speed V of the original voice at the time of the re-utterance can be adjusted every time the voice is reproduced/stopped. As a result, the transcription support device 100 according to the present embodiment can promptly support the work in accordance with the level of proficiency of work performed by the user U. The transcription support device 100 according to the present embodiment can therefore achieve the increased convenience (or can realize a highly convenient support service).

### Effects of Embodiment

The technology in the related art as well as the effects of the present embodiment will be further described below. The transcription speed is typically slower than the reproduction speed of the original voice in the transcription work, which therefore takes a cost (a temporal/economical cost). Accordingly, there has been proposed a technique which supports the transcription work by using the voice recognition. The outcome of voice recognition with high accuracy however cannot be acquired because the original voice has noise mixed therein depending on the recording environment. Now, there has been proposed a system which achieves the accurate voice recognition to support the transcription work by recognizing the user voice input by the user who re-utters the same content as that of the original voice after having listened thereto.

This kind of system in the related art however has the following problem regarding the appropriate speed of reproducing the original voice at the time of the re-utterance. Assuming a use situation where the user re-utters the original voice after having listened thereto for a fixed period of time, for example, the user with the low level of proficiency of work tends to re-utter at a fast rate when the original voice is spoken fast. Therefore, there is a decrease in the accuracy of recognizing the user voice when the user has the low level of proficiency of work, the user voice corresponding to the recorded re-utterance. It is thus desired that the reproduction speed of the original voice at the time of the re-utterance be decreased for the user with the low level of proficiency of work. On the other hand, the user with the high level of proficiency of work can re-utter the voice stably without being influenced by the reproduction speed of the original voice. Therefore, the user with the high level of proficiency of work preferably re-utter the voice while listening to the original voice at a fast speech rate. It is thus desired that the reproduction speed of the original voice at the time of the re-utterance be increased for the user with the high level of proficiency of work. The appropriate speed of reproducing the original voice at the time of the re-utterance varies depending on the level of proficiency of work performed by the user. The system in the related art, on the other hand, is not adapted to adjust the reproduction speed of the original voice at the time of the re-utterance to the appropriate speed according to the level of proficiency of work performed by the user. In other words, the system in the related art does not individually support the text transcription work by the re-utterance for each user, whereby the support service using the system in the related art is not convenient for the user.

Now, the transcription support device according to the present embodiment determines the level of proficiency of work performed by the user on the basis of the original voice to be transcribed, the user voice in which the re-utterance is recorded, the text (second text) obtained by editing the recognized character string (first text), and the reproduction information on the original voice. The transcription support device according to the present embodiment then determines the reproduction speed of the original voice at the time of the rep-utterance from the determination result of the level of proficiency of work performed by the user. That is, the transcription support device according to the present embodiment is constructed to determine the reproduction speed of the original voice at the time of the re-utterance in accordance with the level of proficiency of work performed by the user.

As a result, the transcription support device according to the present embodiment can adjust the reproduction speed of the original voice at the time of the re-utterance to the speed appropriate for each user. The transcription support device according to the present embodiment can therefore support the text transcription work by the re-utterance in accordance with the level of proficiency of work performed by the user, thereby achieving improved convenience (realizing the support service with enhanced convenience).

Device

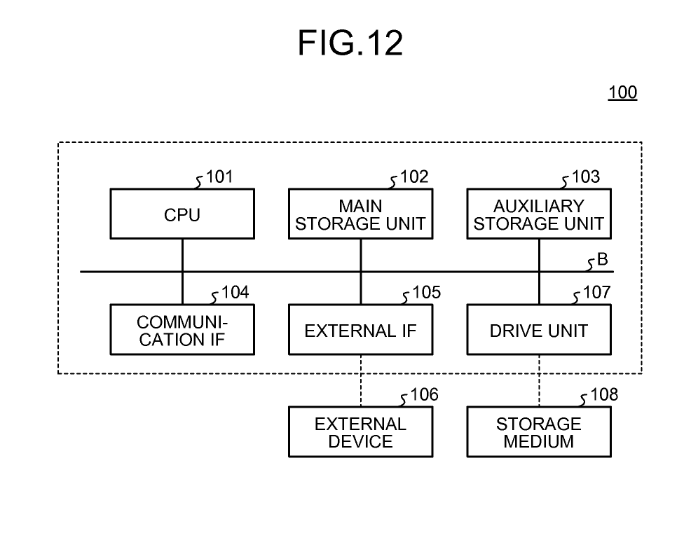

FIG. 12 is a diagram illustrating a configuration example of the transcription support device 100 according to the aforementioned embodiment. As illustrated in FIG. 12, the transcription support device 100 according to the embodiment includes a CPU (Central Processing Unit) 101, a main storage unit 102, an auxiliary storage unit 103, a communication IF (interface) 104, an external IF 105, and a drive unit 107. Each unit in the transcription support device 100 is connected to each other via a bus B. The transcription support device 100 according to the embodiment is thus equivalent to a typical information processing device.

The CPU 101 is an arithmetic unit provided to perform overall control on the device and realize an installed function. The main storage unit 102 is a storage unit (memory) in which a program and data are held in a predetermined storage region. The main storage unit 102 is ROM (Read Only Memory) or RAM (Random Access Memory), for example. The auxiliary storage unit 103 is a storage unit including a storage region with a greater capacity than that of the main storage unit 102. The auxiliary storage unit 103 is a non-volatile storage unit such as an HDD (Hard Disk Drive) or a memory card. The CPU 101 therefore performs the overall control on the device and realizes the installed function by reading the program or data from the auxiliary storage unit 103 onto the main storage unit 102 and executing the process.

The communication IF 104 is an interface which connects the device to the data transmission line N, thereby allowing the transcription support device 100 to perform data communication with another external device (another information processing device such as the user terminal 200) connected through the data transmission line N. The external IF 105 is an interface which allows data to be transmitted/received between the device and an external device 106. The external device 106 corresponds to a display (such as a “liquid crystal display”) which displays various information such as a processing result or an input device (such as a “numeric keypad”, a “keyboard”, or a “touch panel”) which accepts an operation input, for example. The drive unit 107 is a control unit which performs writing/reading to/from a storage medium 108. The storage medium 108 is a flexible disk (FD), a CD (Compact Disk), or a DVD (Digital Versatile Disk), for example.

Moreover, the transcription support function according to the aforementioned embodiment is realized when each of the aforementioned functional units is operated in a coordinated manner by executing the program in the transcription support device 100, for example. In this case, the program is provided while being recorded in a storage medium that can be read by a device (computer) in the execution environment, the program having an installable or executable file format. In the transcription support device 100, for example, the program has a modular construction including each of the aforementioned functional units where each functional unit is created in the RAM of the main storage unit 102 by the CPU 101 reading the program from the storage medium 108 and executing the program. Note that the program may be provided by another method where, for example, the program is stored in an external device connected to the Internet and download ed via the data transmission line N. Alternatively, the program may be provided while incorporated into the ROM of the main storage unit 102 or the HDD of the auxiliary storage unit 103 in advance. While there has been described the example where the transcription support function is implemented by installing the software, a part or all of each functional unit included in the transcription support function may be implemented by installing hardware, for example.

Moreover, in the aforementioned embodiment, there has been described the configuration where the transcription support device 100 includes the original voice acquisition unit 11, the user voice acquisition unit 12, the user voice recognition unit 13, the reproduction control unit 14, the text acquisition unit 15, the reproduction information acquisition unit 16, and the reproduction speed determination unit 17. Alternatively, there may be adapted a configuration of providing the aforementioned transcription support function where, for example, the transcription support device 100 is connected to an external device including a part of the function of these functional units through the communication IF 104 and performs data communication with the external device being connected, thereby allowing each functional unit to be operated in a coordinated manner. Specifically, the aforementioned transcription support function is provided when the transcription support device 100 performs data communication with an external device including the user voice acquisition unit 12 and the user voice recognition unit 13 so that each functional unit is operated in the coordinated manner. The transcription support device 100 according to the aforementioned embodiment can therefore be applied to a cloud environment, for example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transcription support device comprising:
a first voice acquisition unit configured to acquire a first voice to be transcribed;
a second voice acquisition unit configured to acquire a second voice uttered by a user;
a recognizer configured to recognize the second voice to generate a first text;
a text acquisition unit configured to acquire a second text obtained by correcting the first text by the user;
an information acquisition unit configured to acquire reproduction information representing a reproduction section of the first voice;
a determination unit configured to determine a reproduction speed of the first voice on the basis of the first voice, the second voice, the second text, and the reproduction information; and
a controller configured to reproduce the first voice at the determined reproduction speed.

2. The device according to claim 1, wherein
the determination unit includes
a first speech rate estimation unit configured to calculate an estimated value of a first speech rate corresponding to a speech rate of the first voice, on the basis of the first voice, the second text, and the reproduction information,
a second speech rate estimation unit configured to calculate an estimated value of a second speech rate corresponding to a speech rate of the second voice on the basis of the second voice and the second text, and
an adjustment amount calculator configured to calculate an adjustment amount to determine the reproduction speed of the first voice, on the basis of the estimated value of the first speech rate and the estimated value of the second speech rate, and
the determination unit determines the reproduction speed by multiplying the number of data samples per unit time in the first voice by the adjustment amount and setting the multiplied value to be the number of data samples after adjustment.

3. The device according to claim 2, wherein
the first speech rate estimation unit
acquires a voice corresponding to the second text from the first voice on the basis of the reproduction information,
specifies a first utterance section in which the user has uttered in the acquired voice by making correspondence relation between a phoneme sequence obtained by converting the second text in a pronunciation unit and the acquired voice, and
calculates the estimated value of the first speech rate from a length of the phoneme sequence and a length of the first utterance section.

4. The device according to claim 2, wherein
the second speech rate estimation unit
specifies a second utterance section in which the user has uttered in the second voice by making correspondence relation between a phoneme sequence obtained by converting the second text in a pronunciation unit and the second voice, and
calculates the estimated value of the second speech rate from a length of the phoneme sequence and a length of the second utterance section.

5. The device according to claim 2, wherein
the adjustment amount calculator
calculates, when a reproduction method of the first voice is continuous reproduction, the adjustment amount on the basis of the estimated value of the first speech rate and a value of a voice recognition speech rate that is set in order to recognize the second voice, and
calculates, when the reproduction method of the first voice is intermittent reproduction, the adjustment amount on the basis of the set value of the voice recognition speech rate, the estimated value of the first speech rate, and the estimated value of the second speech rate.

6. The device according to claim 5, wherein, in performing the continuous reproduction, the adjustment amount calculator
calculates a first speech rate ratio of the estimated value of the first speech rate to the set value of the voice recognition speech rate, and
divides the set value of the voice recognition speech rate by the estimated value of the first speech rate to calculate a divided value as the adjustment amount, when the first speech rate ratio is greater than a first threshold.

7. The device according to claim 5, wherein, in performing the continuous reproduction, the adjustment amount calculator
calculates a first speech rate ratio of the estimated value of the first speech rate to the set value of the voice recognition speech rate; and
sets the adjustment amount to 1 when the first speech rate ratio is smaller than or equal to a first threshold.

8. The device according to claim 5, wherein, in performing the intermittent reproduction, the adjustment amount calculator
calculates a second speech rate ratio of the estimated value of the first speech rate to the estimated value of the second speech rate as well as a third speech rate ratio of the estimated value of the second speech rate to the set value of the voice recognition speech rate, and
sets the adjustment amount to a predetermined value larger than 1 when the second speech rate ratio is greater than a second threshold and the third speech rate ratio is an approximation of 1.

9. The device according to claim 5, wherein, in performing the intermittent reproduction, the adjustment amount calculator
calculates a second speech rate ratio of the estimated value of the first speech rate to the estimated value of the second speech rate as well as a third speech rate ratio of the estimated value of the second speech rate to the set value of the voice recognition speech rate, and
divides the set value of the voice recognition speech rate by the estimated value of the first speech rate to calculate a divided value as the adjustment amount when the second speech rate ratio is smaller than or equal to a second threshold and is an approximation of 1, and the third speech rate ratio is greater than a third threshold.

10. The device according to claim 5, wherein, in performing the intermittent reproduction, the adjustment amount calculation unit
calculates a second speech rate ratio of the estimated value of the first speech rate to the estimated value of the second speech rate as well as a third speech rate ratio of the estimated value of the second speech rate to the set value of the voice recognition speech rate, and
sets the adjustment amount to 1 when any one of following conditions is satisfied, the following conditions including
the third speech rate ratio is not an approximation of 1,
the second speech rate ratio is not an approximation of 1, and
the third speech rate ratio is smaller than or equal to a third threshold.

11. A transcription support method comprising:
acquiring a first voice to be transcribed;
acquiring a second voice uttered by a user;
recognizing the second voice to generate a first text;
acquiring a second text obtained by correcting the first text by the user;
acquiring reproduction information representing a reproduction section of the first voice;
determining a reproduction speed of the first voice on the basis of the first voice, the second voice, the second text, and the reproduction information; and
reproducing the first voice at the determined reproduction speed.

12. A computer program product comprising a computer-readable medium containing a transcription support program that causes a computer to function as:
a unit to acquire a first voice to be transcribed;
a unit to acquire a second voice uttered by a user;
a unit to recognize the second voice to generate a first text;
a unit to acquire a second text obtained by correcting the first text by the user;
a unit to acquire reproduction information representing a reproduction section of the first voice;
a unit to determine a reproduction speed of the first voice on the basis of the first voice, the second voice, the second text, and the reproduction information; and
a unit to reproduce the first voice at the determined reproduction speed.
